(19) United States
(12) Patent Application Publication
(10) Pub. No.: US 2019/0144701 A1
(43) Pub. Date: May 16, 2019

(54) HEAT INSULATING MATERIAL AND METHOD FOR FORMING COATING OF THE SAME

(71) Applicant: Panasonic Intellectual Property Management Co., Ltd., Osaka (JP)

(72) Inventors: Taichi NAKAMURA, Osaka (JP); Hirohisa HINO, Osaka (JP); Kazuma OIKAWA, Osaka (JP); Shigeaki SAKATANI, Osaka (JP)

(21) Appl. No.: 16/183,064

(22) Filed: Nov. 7, 2018

(30) Foreign Application Priority Data
Nov. 10, 2017 (JP) 2017-216853

(51) Int. Cl. C09D 127/20; C09D 5/18; C09D 127/18

(52) U.S. Cl. CPC C09D 127/20; C09D 127/18; C09D 5/18

(57) ABSTRACT

Provided is a heat insulating material having improved adhesion of interface between a porous body and a polymeric cover material, and a method for forming a coating of the heat insulating material.

The heat insulating material includes a composite material containing an aerogel in a nonwoven fabric, and a cover material including a fluororesin for covering the composite material, in which the cover material has a plurality of grain boundaries on a surface of the cover material.

### CROSS REFERENCE TO RELATED APPLICATIONS

This application is entitled to and claims the benefit of Japanese Patent Application No. 2017-216853, filed on Nov. 10, 2017, the disclosure of which including the specification, drawings and abstract is incorporated herein by reference in its entirety.

### TECHNICAL FIELD

The present invention relates to a heat insulating material and a method for forming a coating of the same. The present invention, particularly, relates to a heat insulating material suitably used to insulate a heat-generating component in a casing and a method for forming a coating of the same.

### BACKGROUND ART

In recent years, there is an increasing demand for environmentally friendly automobiles, aiming to achieve both utilization of automobiles and environmental protection. As an approach for the demand, an engine heat management system is under consideration. For example, fuel efficiency has been considered to be practically improved by retaining the temperature of an engine after completion of warming-up or by maintaining oil temperature required for retaining the temperature of an engine at a cold start in winter.

As means for retaining the temperature of the engine, application of a heat insulating material is contemplated. In this case, the heat insulating material requires bending properties which allow the shape of the engine casing to follow, and heat resistance capable of withstanding the environment in an engine room. As a conventional heat insulating material, there is a porous body having a three-dimensional network silicone skeleton, being covered with a polymeric cover material (see, for example, PTL 1).

FIG. 3 is a sectional view of a conventional heat insulating material disclosed in PTL 1. As shown in FIG. 3, both the front and back surfaces of porous body 301 are covered with polymeric cover material 302. Porous body 301 of PTL 1 includes a three-dimensional network silicone skeleton having pores.

Polymeric cover material 302 contains, for example, polytetrafluoroethylene. Porous body 301 has highly brittle nature and is vulnerable to external force such as tension. For this reason, porous body 301 is protected by covering both the front and back surfaces of porous body 301 with polymeric cover material 302. Specifically, polymeric cover material 302 provides the protective function to porous body 301, so that the heat insulating material is practically used.

### CITATION LIST

### Patent Literature

PTL 1
WO 2016/159196

### SUMMARY OF INVENTION

### Technical Problem

The heat insulating material can exhibit high heat insulation performance taking advantage of pores in porous body 301 as the adhesion of the interface between porous body 301 and polymeric cover material 302 is higher. The heat insulating material in PTL 1, however, cannot exhibit sufficient heat insulation performance because of poor adhesion of the interface between porous body 301 and polymeric cover material 302.

The present invention has been made so as to solve the above-described problem, and an object of this invention is to provide a heat insulating material having improved adhesion of interface between a porous body and a polymeric cover material, and a method for forming a coating of the heat insulating material.

### Solution to Problem

In order to achieve the above object, there is provided a heat insulating material including: a composite material containing an aerogel in a nonwoven fabric; and a cover material including a fluororesin for covering the composite material, in which a surface of the cover material has a plurality of grain boundaries.

The present invention also provides a method for forming a coating of a heat insulating material including: coating a composite material containing an aerogel in a nonwoven fabric with a coating material having fine particles of a fluororesin dispersed; and subjecting the composite material to heat treatment to harden the coating material.

### Advantageous Effects of Invention

Accordingly, the present invention can improve adhesion of the interface between the porous body and the polymeric cover material.

### BRIEF DESCRIPTION OF DRAWINGS

FIG. 1 is a sectional view of a heat insulating material according to Embodiment 1 of the present invention;

FIG. 2 is a diagram showing a surface image of a cover material according to Embodiment 2 of the present invention; and

FIG. 3 is a sectional view of a conventional heat insulating material disclosed in PTL 1.

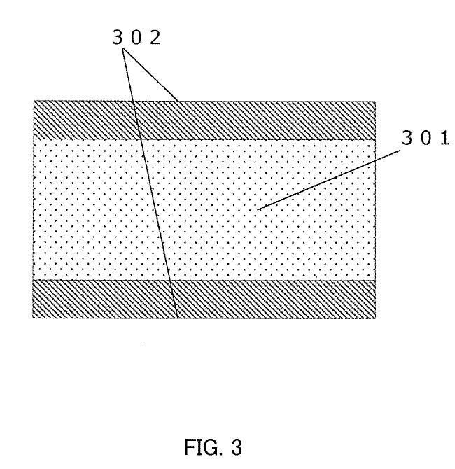

### DESCRIPTION OF EMBODIMENTS

An embodiment of the present invention will be described hereinbelow in detail by reference to the accompanying drawings.

### Embodiment 1

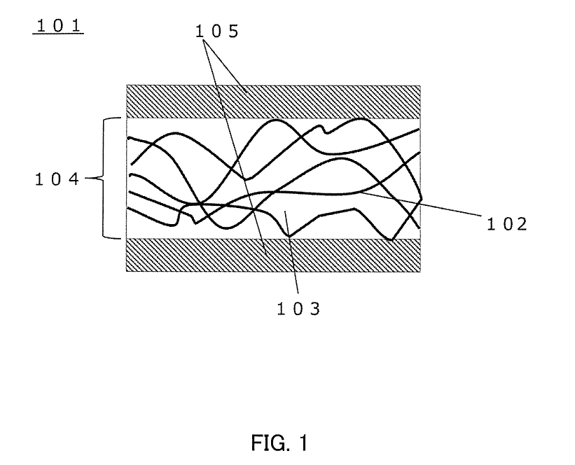

FIG. 1 is a sectional view of heat insulating material 101 according to Embodiment 1 of the present invention. Heat insulating material 101 is configured with composite material 104 containing nonwoven fabric 102 and aerogel 103, cover material 105 which covers around composite material 104. Cover material 105 is a fluororesin in this embodiment.

<Composite Material 104>

Composite material 104 is a sheet having a silica aerogel as aerogel 103 contained in nonwoven fabric 102. Nonwoven fabric 102 has a thickness in the range from 0.05 mm or more to 1.0 mm or less. The silica aerogel has a porous structure with multiple nano-sized pores. Composite material 104 has a thermal conductivity in the range from 0.01 W/mK or more to 0.1 W/mK or less, which is low.

Nonwoven fabric 102 usually has a thermal conductivity in the range from 0.030 W/mK or more to 0.060 W/mK or less. These thermal conductivity values are assumed to be approximately the sum total of the thermal conductivity value of a nonwoven fabric fiber forming nonwoven fabric 102, that is, a solid thermal conduction component of nonwoven fabric 102, and the thermal conductivity value of a heat transfer component of air (nitrogen molecules) existing in voids of the nonwoven fabric fiber.

Composite material 104 can obtain the above-mentioned low thermal conductivity by containing a silica aerogel which is a material having a low thermal conductivity (generally said to be in the range from 0.010 W/mK or more to 0.015 W/mK or less) as aerogel 103 in the voids.

In general, the thermal conductivity of air in a stationary state (hereinafter referred to as “stationary air”) at ordinary temperature is said to be around 0.026 W/mK, and the thermal conductivity of nonwoven fabric 102 is larger than that of the stationary air.

Composite material 104 is a sheet having a lower thermal conductivity than the stationary air. Composite material 104 may have water repellency and sound absorption properties as well as heat insulation properties. Heat resistance or flame retardancy can be imparted to composite material 104 depending on the kind of nonwoven fabric 102.

In this embodiment, acryl oxide is used as nonwoven fabric 102 in order to impart heat resistance or flame retardancy to composite material 104, but other materials may also be used as nonwoven fabric 102. For example, a glass fiber paper may be used as nonwoven fabric 102.

Along with the above, heat insulating material 101 of this embodiment has a lower thermal conductivity than the stationary air. Thus, in this embodiment, composite material 104 contains silica aerogel but may use, for example, porous ceramics such as alumina for applications in which even the heat insulating material having a slightly higher thermal conductivity than the stationary air satisfies heat insulation performance.

<Thermal Conductivity of Composite Material 104>

Composite material 104 used in this embodiment has a thermal conductivity in the range from 0.01 W/m·K or more to 0.1 W/m·K or less. The lower the thermal conductivity of composite material 104 is, the higher the heat insulation effect of composite material 104 becomes, which can reduce the thickness of composite material 104 required to achieve the same heat insulation effect.

Composite material 104 having a thermal conductivity higher than 0.1 W/m·K is not preferable because the heat insulation effect of composite material 104 decreases and, in order to achieve required heat insulation effect, the thickness of composite material 104 needs to be increased.

<Thickness of Composite Material 104>

Composite material 104 has a thickness in the range from 0.05 mm or more to 2 mm or less, and preferably in the range from 0.5 mm or more to 1 mm or less. Composite material 104 having a thickness of less than 0.05 mm is less effective in insulating heat in the thickness direction, so that unless a low thermal conductive material having an extremely low thermal conductivity (not existing at present) is selected as a material of composite material 104, thermal conductivity from one surface to the other surface of composite material 104 cannot be sufficiently suppressed.

<Method for Producing Composite Material 104>

An example of a method for producing composite material 104 will be described.

(1) Mixing of raw materials: As a catalyst, 1.4 wt % of a concentrated hydrochloric acid (12N) is added to a high-molar ratio sodium silicate (a silicate aqueous solution having a Si concentration of 14%), and the mixture is stirred to prepare a sol solution.

(2) Impregnation: The sol solution is poured onto a nonwoven fabric (material: acryl oxide, thickness: 0.4 μm, basis weight: 50 g/m², dimension: 12 cm square), and is pressed thereinto with a roll, thereby impregnating the nonwoven fabric with the sol solution.

(3) The nonwoven fabric impregnated with the sol solution is sandwiched between PP films (thickness of 40 μm×2 sheets) and this is allowed to stand at a room temperature of 23° C. for about 20 minutes to convert the sol to a gel.

(4) Thickness control: After the gelation is confirmed, the nonwoven fabric with the PP films is passed through a biaxial roll in which a gap is set to 650 μm (set including the thickness of the PP films, that is, set the total thickness of composite material 104 to 650 μm), to thereby squeeze excess gel out of the nonwoven fabric, so that the thickness is controlled to a target of 700 μm.

(5) Curing: The gel sheet (nonwoven fabric impregnated with the gel) with the films is placed in a container, and the container is placed in a constant temperature/humidity chamber at a temperature of 85° C./humidity of 85% RH for three hours to prevent drying. This allows silica particles in the nonwoven fabric to grow (a silanol dehydration condensation reaction) and thus, a porous structure contained in the nonwoven fabric is formed.

(6) Film removal: The gel sheet is taken out of the curing container (constant temperature/humidity chamber) and the films are removed from the sheet.

(7) Hydrophobization 1 (hydrochloric acid-immersion step): The gel sheet is immersed in 6 to 12 normal hydrochloric acid and then allowed to stand at an ordinary temperature of 23° C. for one hour to incorporate hydrochloric acid into the gel sheet.

(8) Hydrophobization 2 (siloxane treatment step): The gel sheet is immersed in, for example, a mixture solution of octamethyltrisiloxane, which is a silylating agent, and 2-propanol (IPA), which is an amphiphilic solvent, and allowed to react in a constant temperature chamber at 55° C. for two hours. When trimethylsiloxane bonds start to form, aqueous hydrochloric acid is eliminated from the gel sheet, and the solution around the gel sheet is separated into two liquids. Specifically, a layer of the silylating agent is formed in the upper layer and a layer of the aqueous hydrochloric acid, in the lower layer.

(9) Drying: The gel sheet is transferred to a constant temperature chamber at 150° C., and is dried therein for two hours.

<Cover Material 105>

Cover material 105 uses, as a raw material, a coating material having fine particles of a fluororesin dispersed in water. Cover material 105 is sintered by heating the raw material. Specifically, the raw material is an aqueous coating material in which tetrafluoroethylene particles having a particle size in the range from about 0.2 μm or more to 0.3 μm or less are stabilized by surfactant. This raw material is heated to the melting point of the fine particle (fluororesin) or higher to thereby sinter the fine particles together, so that cover material 105 is formed in a film shape. To achieve better sinterability, hexafluoropropylene is polymerized with tetrafluoroethylene to prepare a polymer with a low melting point. In this embodiment, this polymer (polymer prepared by polymerizing tetrafluoroethylene and hexafluoropropylene) is used.

The fluororesin such as tetrafluoroethylene or hexafluoropropylene has large carbon-fluorine bond energy and is excellent in heat resistance. Therefore, even though hexafluoropropylene is polymerized with tetrafluoroethylene to provide the fluororesin with a low melting point, the fluororesin still has a heat resistance of about 200° C.

A typical fluororesin is perfluoro-alkoxyalkane or ethylene-tetrafluoroethylene copolymer, but the ethylene-tetrafluoroethylene copolymer is not desirable for the raw material of cover material 105 because of lack of heat resistance of about 200° C.

Thus, in this embodiment, hexafluoropropylene is polymerized with tetrafluoroethylene to prepare a polymer with a low melting point. However, even though hexafluoropropylene is polymerized with perfluoro-alkoxyalkane, the obtained polymer does not impair heat resistance of about 200° C., so that perfluoro-alkoxyalkane is desirable for the raw material of cover material 105.

In summary, cover material 105 is preferably one polymer selected from tetrafluoroethylene, hexafluoropropylene, and perfluoro-alkoxyalkane; or a copolymer of two or more kinds thereof.

<Method for Covering Composite Material 104 with Cover Material 105>

An example of the method for covering composite material 104 with cover material 105 will be described.

(1) Raw material stirring step: An aqueous coating material (about 0.2 μm fine particles composed of a copolymer of tetrafluoroethylene and hexafluoropropylene are stabilized by surfactant at a solid content concentration of about 20 wt %) is stirred to uniformly disperse the fine particles in water.

(2) Coating step: The whole composite material 104 is immersed in the stirred aqueous coating material and composite material 104 is taken out at a constant rate.

(3) Hardening step: Composite material 104 immersed in the aqueous coating material is transferred to a constant temperature chamber at 300° C. and kept there for three minutes to volatilize water while the fine particles are sintered on composite material 104 to be hardened. The fine particles thus hardened form cover material 105.

<State of Covering Composite Material 104 with Cover Material 105>

Cover material 105 having an average thickness of 15 μm (minimum thickness of 5 μm, maximum thickness of 80 μm) is formed around composite material 104 by the above-mentioned method for covering composite material 104 with cover material 105.

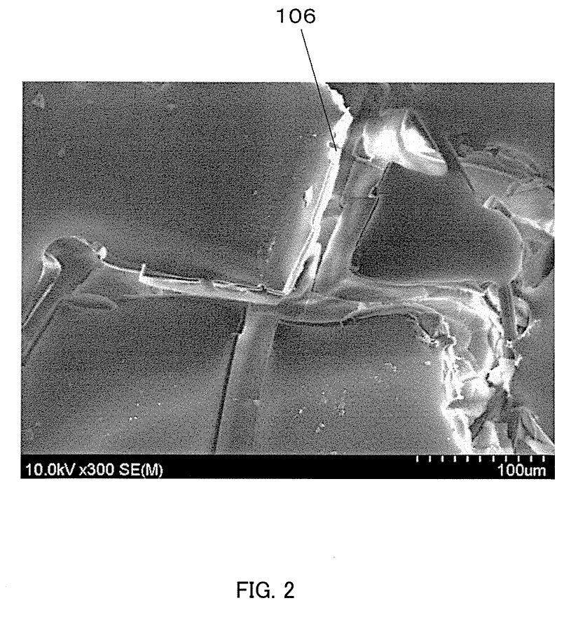

FIG. 2 is a diagram showing an enlarged surface image of cover material 105 according to Embodiment 1 of the present invention. As shown in FIG. 2, a plurality of grain boundaries 106 are formed on the surface of cover material 105 by hardening the aqueous coating material containing the fine particles at a temperature about 50° C. above the melting point of the fine particle composed of a fluororesin which is used in the raw material of cover material 105. This is a characteristic feature of the present invention. The surface of cover material 105 refers to a surface (second surface) opposite to a surface (first surface) facing composite material 104.

Thus, even though the heat insulating material in Embodiment 1 of the present invention is bent, fracture of cover material 105 is prevented by distributing the stress associated with stretching of portions where grain boundaries 106 are formed.

In this embodiment, grain boundaries 106 have a size in the range from 10 μm or more to 500 μm or less, and an average groove width of 50 μm (minimum groove width of 5 μm, maximum groove width of 100 μm). In this embodiment, grain boundaries 106 have a depth of about 3 μm from the surface of cover material 105 and exhibit a V-shaped cross section.

In addition, grain boundaries 106 stay at the surface layer of cover material 105, not reaching the interface with composite material 104. Therefore, the interface between cover material 105 and composite material 104 is satisfactorily in contact with each other, which prevents aerogel contained in composite material 104 from being exposed.

Cover material 105 having an average thickness of less than 5 μm is, however, undesirable because grain boundaries 106 reach the interface with composite material 104.

Hardening of the aqueous coating material containing the fine particles at a temperature about 100° C. above the melting point of the fine particle is undesirable because grain boundaries 106 are not formed, while hardening of the aqueous coating material at a temperature about 20° C. below the melting point thereof is undesirable because grain boundaries 106 reach the interface with composite material 104. The temperature at which the aqueous coating material containing the fine particles is hardened is preferably not less than the melting point of the fine particles within a predetermined range.

(Overall)

The fluoride material used for the fine particles which are the raw material of cover material 105 is not limited to those mentioned above as long as it can form grain boundaries 106.

### INDUSTRIAL APPLICABILITY

The heat insulating material of the present invention is also applicable to heat insulation for preventing lowering of oil temperature in order to retain the temperature of an engine after completion of warming-up or at a cold start in winter.

### REFERENCE SIGNS LIST

101 Heat insulating material
102 Nonwoven fabric
103 Aerogel
104 Composite material
105 Cover materials
106 Grain boundary
301 Porous body
302 Polymeric cover materials

1. A heat insulating material comprising:
a composite material containing an aerogel in a nonwoven fabric; and
a cover material including a fluororesin for covering the composite material,
wherein a surface of the cover material has a plurality of grain boundaries.

2. The heat insulating material according to claim 1, wherein the plurality of grain boundaries do not reach the composite material.

3. The heat insulating material according to claim 1, wherein the plurality of grain boundaries have a size in a range from 10 μm or more to 500 μm or less.

4. The heat insulating material according to claim 1, wherein the plurality of grain boundaries have a groove width in a range from 5 μm or more to 100 μm or less.

5. The heat insulating material according to claim 1, wherein the cover material is composed of one polymer selected from tetrafluoroethylene, hexafluoropropylene, and perfluoro-alkoxyalkane, or a copolymer of two or more kinds thereof.

6. A method for forming a coating of a heat insulating material comprising:
coating a composite material containing an aerogel in a nonwoven fabric with ₐ coating material having fine particles of a fluororesin dispersed; and
subjecting the composite material to heat treatment to harden the coating material.

7. The method for forming a coating of a heat insulating material according to claim 6, wherein the temperature of the heat treatment is not less than a melting point of the fine particles.

8. The method for forming a coating of a heat insulating material according to claim 6, wherein the temperature of the heat treatment is not more than 100° C. above the melting point of the fine particles.

9. The method for forming a coating of a heat insulating material according to claim 6, wherein the coating material is dispersed in water.

10. The method for forming a coating of a heat insulating material according to claim 6, wherein the fine particles are composed of one polymer selected from tetrafluoroethylene, hexafluoropropylene, and perfluoro-alkoxyalkane, or a copolymer of two or more kinds thereof.
